(19) United States
(12) Patent Application Publication
(10) Pub. No.: US 2019/0137647 A1
(43) Pub. Date: May 9, 2019

(54) Method and Apparatus for Formation Evaluation

(71) Applicant: Weatherford Technology Holdings, LLC, Houston, TX (US)

(72) Inventors: Qiuzhao Dong, Houston, TX (US); Tommy Binford, Houston, TX (US); Craig Barnet, Houston, TX (US); Derick Zurcher, Houston, TX (US)

(21) Appl. No.: 15/804,412

(22) Filed: Nov. 6, 2017

(51) Int. Cl. G01V 3/30; H01Q 7/00; H01Q 21/06

(52) U.S. Cl. CPC G01V 3/30; H01Q 21/062; H01Q 7/00

(57) ABSTRACT

Antenna arrays for well logging/measuring tools are disclosed. The antenna arrays include at least four antenna wire elements. Current provided to or sensed by each of the antenna wire elements can be independently controlled or sensed. The antenna arrays can be configured to produce or sense electromagnetic dipole moments in any direction in three dimensional space.

### FIELD OF THE INVENTION

The present application relates to formation evaluation, and more particularly, to methods and systems for resistivity measurements.

### BACKGROUND

A measurement of electromagnetic (EM) properties of earth formation penetrated by a borehole has been used for decades in hydrocarbon exploration and production operations. The resistivity of hydrocarbon is greater than saline water. A measure of formation resistivity can, therefore, be used to delineate hydrocarbon bearing formations from saline water bearing formations. Electromagnetic borehole measurements are also used to determine a wide range of geophysical parameters of interest including the location of bed boundaries, the dip of formations intersecting the borehole, and anisotropy of material intersected by the borehole. Electromagnetic measurements are also used to “steer” the drilling of the borehole.

Borehole instruments, or borehole “tools”, used to obtain EM measurements typically comprise one or more antennas or transmitting coils which are energized by an alternating electrical current. Resulting EM energy interacts with the surrounding formation and borehole environs by propagation or by induction of currents within the borehole environs. One or more receivers respond to this EM energy or current. A single coil or antenna can serve as both a transmitter and a receiver. Parameters of interest, such as those listed above, are determined from the response of the one or more receivers. Response of one or more receivers within the borehole apparatus may be telemetered to the surface of the earth via conveyance means that include a wireline or a drill string equipped with a borehole telemetry system, such as mud pulse, sonic or electromagnetic telemetry. Alternately, the response of one or more receivers can be stored within the borehole tool for subsequent retrieval at the surface of the earth.

Standard induction and wave propagation EM tools are configured with transmitter and receiver coils with their magnetic moments aligned with the major axis of the tool. More recently, induction tools with three axis coils and wave propagation MWD or LWD tools with antennas (coils) whose magnetic moments are not aligned with the tool axis are being produced and used. These MWD or LWD propagation tools, with antenna dipole axes tilted with respect to the tool axis, can locate boundaries with resistivity differences as a function of tool azimuth. Tools with coils aligned with the tool axis cannot locate boundaries with resistivity changes as a function of tool azimuthal angle. The azimuthal resistivity response feature of an electromagnetic MWD or LWD tool is most useful in direction or “geosteering” the drilling direction of a well in a formation of interest. More specifically, the distance and direction from the tool to a bed (such as shale) bounding the formation of interest, or water interfaces within the formation of interest, can be determined from the azimuthal resistivity response of the tool. Using this information, the drill bit can be directed or “steered”, in real time, to stay within the formation zone of interest so as to avoid penetrating non hydrocarbon bearing formations with the borehole.

Prior art MWD or LWD tools that make azimuthal EM measurements employ a combination of separate axially aligned antennas and antennas whose magnetic moments are tilted at an angle with respect to the tool axis. Such tools, for example, are described in U.S. Pat. No. 6,476,609 issued to Bittar, and U.S. Pat. No. 6,297,639 issued to Clark et al. These tools have a fixed inclination and azimuth response, and can only transmit or receive magnetic fields at a particular orientation relative to the tool. These patents include a rotational position sensor and a processor to identify the azimuthal angle of the magnetic moments as the tool rotates during drilling. Furthermore, the antennas with different dipole orientations located at different axial spacings along the length of the tool lack a common dipole origin point. This fact precludes vector addition of the dipole moments to form a new dipole moment, in any direction, with the same origin point. Multiple antennas at differing axial spacings also increase tool production and maintenance cost, and further reduces mechanical tool strength.

Electromagnetic antennas have been designed for MWD or LWD tools for the past three decades. The use of highly magnetic permeable material in the design of these antennas has been around for the past two decades and antennas that generate a magnetic field in directions other than the tool axis directions have been designed mostly in the past decade. U.S. Pat. No. 4,536,713 issued to Davis et al. describes a high permeability magnetic material disposed in a drill collar used for measuring mud resistivity outside the collar in the annulus region between the drill collar and the borehole wall. U.S. Pat. No. 5,138,263 issued to Towle describes placing magnetic material between an antenna wire and an MWD collar to electromagnetically couple the antenna signal to the formation.

U.S. Pat. No. 6,181,138 issued to Hagiwara describes an arrangement of three antennas disposed around a drill collar in which each antenna is composed of a coil wire disposed within a plane and oriented at an angle with respect to the tool axis. Each of the three antennas is basically a wire around the outside of a usually steel drill collar, wherein the path of the wire is located in a plane intersecting the drill collar. The normal vector to this plane can be described as having an inclination angle and an azimuthal angle. Azimuthal angle as it is being used here is the angle around the tool perpendicular to the tool axis. The origin of the vector is the center of the plane containing the antenna. All of the three antennas have the same centroid or geometric center and, as such, produce magnetic vectors that have a common origin or are co-located. The patent also describes on the same tool additional antennas spaced apart along the tool axis and oriented at a second angle with respect to the tool axis. The additional antennas are disposed within a plane that makes an angle of zero degrees in the same manner that standard wave propagation resistivity tools are constructed. The patent also discloses using the antennas in combination with a rotational position sensor and a processor contained within the MWD tool. The patent also describes combining the three antennas to electrically orient the antenna magnetic dipole moment to any azimuthal angle, but cannot change the inclination angle. This antenna design places coils around a drilling collar in a region of reduced diameter or “necked down” region. It is well known in the art that reducing the outer diameter of a drilling collar weakens it in that area and causes the collar to be more prone to mechanical failure. In this design also the coils must be covered with a non-conducting layer which must go all the way around the collar for the extent of the tilted coils. Non-conductive coverings presently used in the art such as fiberglass, rubber, epoxy, ceramics or plastic are subject to wear due to abrasion which occurs between the tool and the borehole wall, and are not as strong as the collar material. Because the non-conducting region must encircle the collar it is likely to contact the borehole wall unless the collar is further “necked down” causing further weakness. An extreme penalty is paid by “necking down” drilling tubulars. It is well known to those skilled in the art that reducing the outer diameter of a cylindrical member reduces the torsional and bending stiffness proportional to the forth power of the radius. For example, reducing the diameter of a 5 inch (12.7 centimeter) tubular to 4 inches (10.2 centimeters) reduces the torsional and bending stiffness by 59%.

U.S. Pat. No. 6,476,609 issued to Bittar describes at least one antenna disposed in a plane and oriented at an angle with respect to the tool axis and another antenna displaced along the tool axis from the first antenna and disposed in a plane and oriented in a different angle with respect to the tool axis. This patent also includes a rotational position sensor and a processor.

U.S. Pat. No. 7,038,457 issued to Chen and Barber, and U.S. Pat. No. 3,808,520 issued to Runge, describe co-located triaxial antenna construction in which three orthogonal coils are wound around a common point on a borehole logging tool. These patents describe the virtues of having antennas with three orthogonal dipole moments all passing through the same point in the center of the logging tool. The teachings of both patents are more suitable for tools conveyed into a borehole by wireline, rather than tools used in drilling a borehole, because the disclosed coil windings would compromise the strength and durability of an MWD or LWD tool. Runge describes a triaxial antenna located in the center of a tool with non-conducting tool housing or “mandrel” around it. This design is clearly not appropriate for MWD or LWD embodiment. It is known to those of ordinary skill in the MWD or LWD art that a non-conducting tool body does not have the strength to support the severe mechanical requirements of tools used in drilling. Chen and Barber describe a technique for implementing an antenna structure with co-located magnetic dipole moments in which the transverse coils penetrate a mandrel through openings in the tool body. While this may be appropriate for wireline applications, openings in the tool body in which a coil is placed will cause weakness in the tool body. In addition provision must be made for drilling fluid or drilling “mud” to flow down within the body of an MWD or LWD tool. This mud usually flows in a conduit or channel in the center of the MWD or LWD tool, which is typically a drill collar. Embodied in a MWD or LWD system, the Chen and Barber design must somehow be modified to divert the mud away from the coils and the openings in the tool body thereby adding complexity and cost to the manufacture of the tool. Another problem encountered in embodying the Chen and Barber design as an MWD or LWD system is that, owing to the required non-conductive covering which is disposed around the circumference of the tool, the coils are not protected from abrasion which occurs between the tool and the borehole wall during drilling.

A more robust antenna design suitable for MWD or LWD application is described in U.S. Pat. No. 5,530,358 issued to Wisler et al. This antenna is integrated into a drilling tubular affording maximum strength and abrasion resistance, One of the key components of the Wisler et al. system is the antenna is composed of grooves and wire pathways disposed beneath the surface of the drilling tubular surface to avoid any abrasion and so as not to reduce the strength of the tubular. The patent further discloses disposing magnetic material between the wire and the grooves.

U.S. Pat. No. 7,057,392 issued to Wang et al describes an antenna with grooves on the outside of the tool that are oriented “substantially orthogonal to the tool axis”. The antenna construction and grooves are similar to those described in U.S. Pat. No. 5,530,358.

### BRIEF DESCRIPTION OF THE DRAWINGS

FIGS. 1A-IC show antenna groove elements.

FIGS. 2A-2D show antenna hole elements.

FIGS. 3A and 3B show embodiments of antenna hole elements.

FIG. 4 shows an embodiment of a tool section including an antenna.

FIGS. 5A-5D show component antenna wires of an antenna.

FIGS. 6A and 6B show an antenna transmitting a Z-component dipole moment.

FIGS. 7A and 7B show an antenna transmitting a Y-component dipole moment.

FIGS. 8A and 8B show an antenna transmitting an X-component dipole moment.

FIG. 9 shows a flow diagram of an antenna transmission circuit.

FIG. 10 shows a flow diagram of an antenna receiver circuit.

FIG. 11 shows an embodiment of a tool section including an antenna.

FIGS. 12A-12D show component antenna wires of an antenna.

FIGS. 13A and 13B show an antenna transmitting a Z-component dipole moment.

FIGS. 14A and 14B show an antenna transmitting a Y-component dipole moment.

FIGS. 15A and 15B show an antenna transmitting an X-component dipole moment.

FIGS. 16A-16C show an embodiment of an antenna.

FIGS. 17A-17C show an embodiment of an antenna.

FIGS. 18A-18C show an embodiment of an antenna.

### DESCRIPTION

U.S. Pat. No. 8,471,563, the contents of which are incorporated herein by reference in their entirety, describes a robust, steerable, magnetic dipole antenna for 10 kilohertz (kHz) to 10 megahertz (MHz) Measurement-While-Drilling (MWD) or Logging-While-Drilling (LWD) applications. The antenna elements comprise one or more antenna “hole” elements in addition to one or more antenna “groove” elements in a steel tool body, which is typically a drill collar. Antenna hole elements and antenna groove elements, as described in U.S. Pat. No. 8,471,563, may also be used for the antenna embodiments described in the instant disclosure. This embodiment produces an extremely robust antenna that does not significantly reduce the structural integrity of the tool body in which it is disposed. The antenna embodiment is also relatively wear resistant to the harsh MWD or LWD environments. For brevity, both MWD and LWD systems/tools will be referred to as “MWD” systems/tools. As used herein, the term “well logging/measuring tool” encompasses “MWD” systems/tools and wireline tools.

Using antenna hole elements perpendicular to the tool axis only, a magnetic field can be generated or received perpendicular to the major axis of the tool. Using groove elements parallel to the tool axis only a magnetic vector can be generated or received parallel to the major axis of the tool. Using both hole and groove antenna elements, a magnetic field may be generated or received at any inclination angle. Antenna element responses can subsequently be used to determine the location of the tool and to steer the direction of the MWD system during a drilling operation.

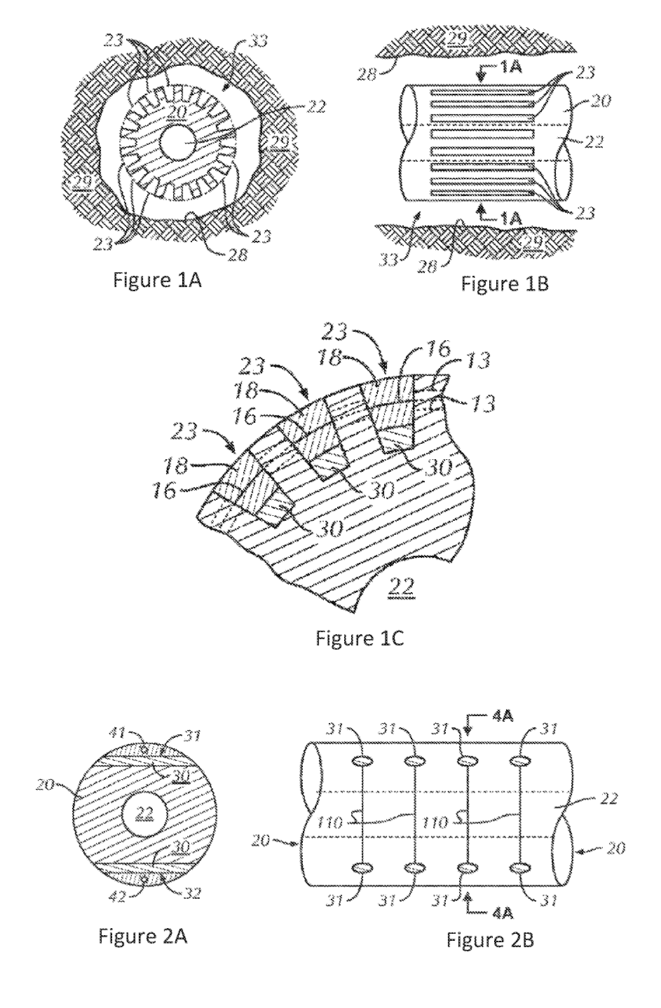

FIGS. 1A and 1B show antenna recesses or “grooves” configuration used in U.S. Pat. No. 8,471,563 and used in embodiments described in the instant disclosure. These grooves are parallel to the major axis of the logging tool. FIG. 1A shows an azimuthal cross section view at A-A of a tool housing 20 for the steerable dipole antenna section of a MWD tool. Grooves 23 are disposed azimuthally around the outer surface of the tool housing 20. The azimuthal spacing may or may not be equal. According to some embodiments, the tool housing 20 is a drill collar comprising a conduit 22 through which drilling fluid flows. The tool housing 20 is shown disposed within a borehole 33 defined by a borehole wall 28 and penetrating an earth formation 29. FIG. 1B shows a side view of the of the tool housing 20, and clearly shows a “set” of grooves 23, with each groove being essentially parallel to the major axis of the tool housing 20. Each groove is, therefore, essentially parallel to the major axis of the MWD logging tool. The axial position of each groove in the set is preferably the same along the tool body 20.

FIG. 1C is a cross sectional view of the wall of the tool housing 20 illustrating elements of the antenna within two exemplary grooves 23 from the set of grooves shown in FIGS. 1A and 1B. The radially inward or “bottom” portion of each groove comprises ferromagnetic material 30. The radially outward or “top” of each groove comprises non-conducting material 18. Antenna wire 16 traverses the non-conducting material in a direction that at any point is essentially perpendicular to the major axis of the tool housing 20. Antenna wire within the wall of the tool housing 20 between grooves, disposed in a wireway 13, is indicated by broken lines. Details of the wireway 13 are disclosed in U.S. patent application Publication Ser. No. 11/685,046 filed Mar. 12, 2007 and assigned to the assignee of the present invention, which is entered into this disclosure in its entirety by reference.

To avoid catastrophic wear patterns of antenna elements oriented perpendicular to the tool axis, hole antenna elements are employed. These elements comprise drilled holes filled with ferrite and a thin saw cut or “slit” along the hole length. Within the context of this disclosure, the term “hole antenna element” refers to a part of the tool comprising a tunnel or hole within the wall of the tool whose center is a chord in a cylindrical section of the tool, a slit extending from the hole to the outer surface of the tool, the outer surface of the tool near the slit, and an antenna wire element traversing the hole and located between the hole and the tool outer surface.

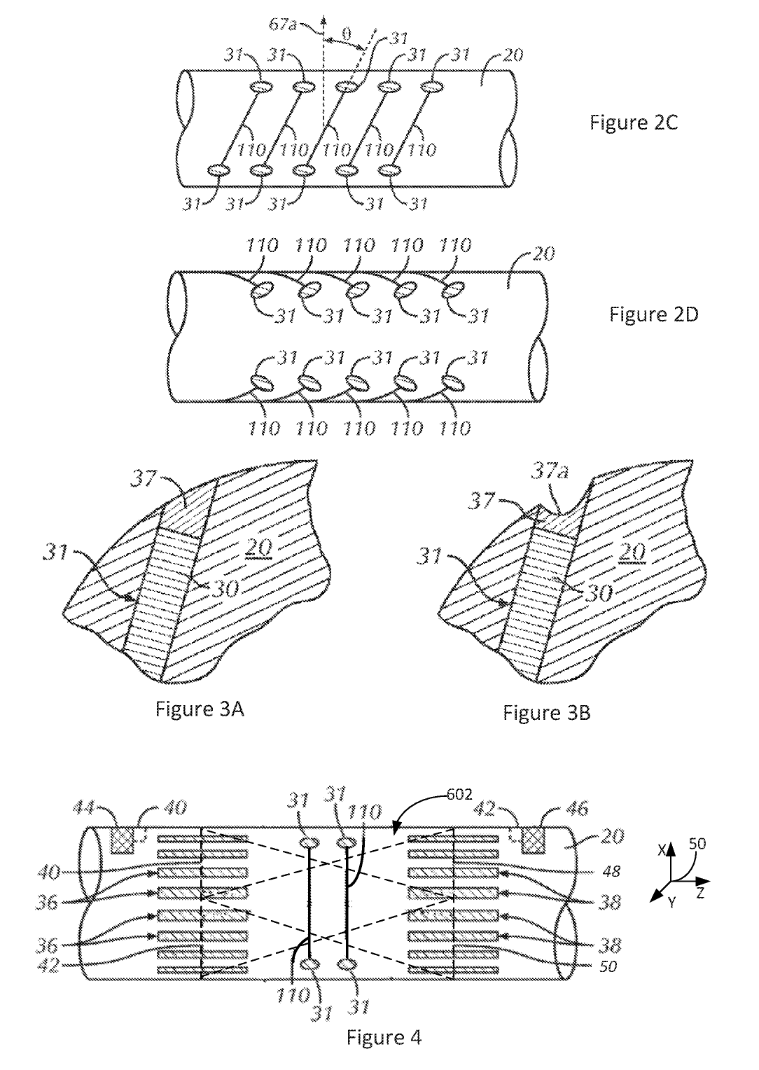

FIG. 2A is a radial cross sectional view at A-A of two hole antenna elements or 31 and 32 oriented with their major axes perpendicular to the tool housing axis, traversing the wall of the tool housing 20, and azimuthally spaced at 180 degrees. The major axis of each hole is also preferably perpendicular to the radius of the tool housing 20. The holes 31 and 32 contain ferromagnetic material 30 such as ferrite. Corresponding antenna wires are denoted by 41 and 42, respectively. The conduit through which drilling fluid flows is again denoted by 22. FIG. 2B illustrates a side view of the same tool housing 20 comprising a plurality or “set” of axially hole antenna elements, the openings of the holes are denoted by 31. Hole antenna elements 32 (see FIG. 2A) are on the opposite side of the tool housing 20 and, therefore, are not shown in FIG. 2B. The thin saw cuts or “slits” which intersect the holes along their length are denoted by 110. The slits 110 are filled with non-conductive wear resistant material that will be subsequently discussed in more detail. The axial spacing of the elements in the set is preferably equal.

An alternate embodiment of the antenna hole elements is shown in FIGS. 2C and 2D in which the holes and slits are positioned at an angle Φ at 67 that is not perpendicular to the major axis of the tool 20. In this case the hole part of each hole elements, indicated by openings 31 and 32, are located along a chord of elliptical conic sections of the tool body, wherein the planes defining the conic sections are not perpendicular to the tool axis. More specifically, FIG. 2C illustrates a side view of the set of hole elements 32, and FIG. 2D is a side view showing portions of the sets of opposing hole elements 32 and 32. This embodiment will provide a magnetic vector that is not perpendicular to the major axis of the tool 20, but makes an angle Q with the perpendicular vector 67a as shown in FIG. 2C. In this manner, the antenna generates or detects a field component in the perpendicular direction 67a as well as a component in the axial direction of the major axis of the tool 20. Although not shown, one familiar with the art of antenna design will realize that the hole elements can have different tilt angles, Φ, and can be located at different azimuthal locations relative to one another to achieve alternate embodiment antennas with differing characteristics.

FIG. 3A illustrates a more detailed view of one end of a single hole element 31 perpendicular to the axis of the logging tool 20. The hole 31 is preferably a round conduit, although other shapes can be used. The azimuthally spaced hole elements 32 (see FIG. 2A) are identical to the hole element 31. In the present embodiment of the steerable dipole antenna system, openings of the holes are essentially round holes approximately 0.25 inches (0.64 centimeters) in diameter. The holes contain ferromagnetic material 30 and are terminated at each end (only one end shown) by non-conducting inserts 37. The ferromagnetic material 30 is recessed at least 0.25 inches (0.64 centimeters) from the outer surface of the tool housing 20. The slits 110 (see FIG. 2B) are very thin and preferably less than 1/16 inch (0.16 cm) wide so that they will not erode during drilling.

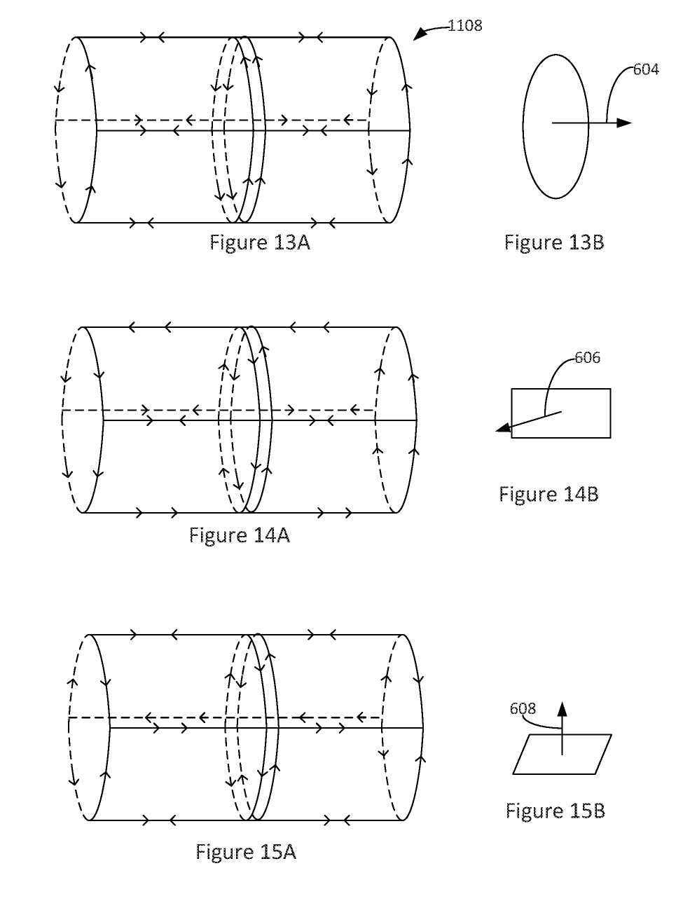

Additional details concerning hole antenna elements and their operation are described in FIGS. 13A and 13B and the description thereof of the incorporated U.S. Pat. No. 8,471,563. It should be noted that the hole antenna elements 31, with the incorporated ferrite material 30, serve to boost the strength of antenna wires running through the wireways in the wall of the tool housing. According to some antenna embodiments described herein, such a power boost may not be needed. Thus, the hole antenna elements may be considered optional, depending on operating constraints. In embodiments that do not include hole antenna elements, the antenna wires that run roughly parallel to the tool axis are simply run through wireways below the surface tool housing.

FIG. 3B illustrates conceptually the results of borehole wear on the ends of the hole element shown in FIG. 3A. The wear of the non-conducting insert 37 is illustrated by the contour of the surface 37a. As discussed above, if the diameter of the hole is 0.25 inches (0.64 centimeters) or less, and the radial length of the non-conducting insert is greater than 0.25 inches (0.64 centimeters), the depth to which the insert erodes is 0.25 inches (0.64 centimeters) or less, and does not damage the operation of the antenna.

FIG. 4 is a side view of the exterior of a MWD logging tool section 20 housing an embodiment of a steerable magnetic dipole antenna, as disclosed herein. The tool section 20 comprises a first set 36 and a second set 38 of axially grooved and laterally spaced antenna elements. The grooves in each set 36 and 38 are essentially parallel to the major axis of the tool section 20, and are azimuthally disposed peripherally around the outer surface of the housing of the tool section 20 (see FIGS. 1A and 1B).

The tool section 20 also includes transverse directed hole antenna elements with hole openings 31. A second set of hole antenna elements with hole openings 32 (see FIG. 2A) is disposed on the other side of the tool displaced by 180 degrees of azimuth angle and, therefore, not shown in this view. These transverse hole elements (see FIGS. 2A and 3A) are disposed between the first and second sets of axial grooves 36 and 38, respectively.

The tool section 20 also includes an antenna 160, which comprises four antenna wires 40, 42, 48, and 50. Broken lines represent the antenna wires beneath the outer surface on the tool 20. Sections of antenna wires 40 and 42, which are perpendicular to the axis of the tool section 20, traverse the groove set 36. Sections of antenna wires 48 and 50, which are perpendicular to the axis of the tool section 20, traverse the groove set 38. Sections of antenna wires also traverse tool housing material between grooves within wireways (not shown).

The dotted lines represent sections of the antenna wires 40, 42, 48, and 50 disposed in non-conducting material or within in wireways within the wall of the tool section 20. As explained in more detail below, antenna wires 40, 42, 48, and 50 combine to form an antenna 602. Axial portions of the antenna wires 40, 42, 48, and 50, which are parallel to the axis of the tool section 20, can be disposed within in a common wireway or in separate wireways and are disposed above the ferrite in the hole antenna elements 31. Slits between the holes are again denoted as 110. The ends of the antenna wires 40, 42, 48, and 50 terminate at antenna wire connection boxes 44 and 46, respectively (note that antenna wire connections boxes for antenna wires 48 and 50 are not shown). The antenna wire connection boxes serve as terminals through which the antenna wires 40, 42, 48, and 50 are connected electrically with power supplies, control electronics, and the telemetry system of MWD logging tool.

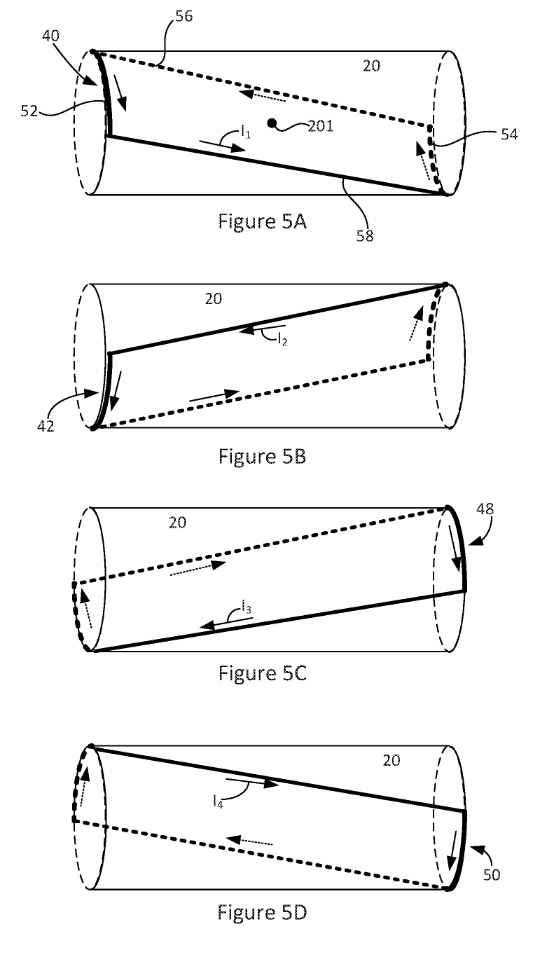

FIGS. 5A-5D show the configurations of antenna wires 40, 42, 48, and 50, respectively, of the antenna 602 within the tool section 20. Note that in FIGS. 5A-5D solid lines represent lines that are on the “front” of the drawings and dashed lines represent lines that are on the “back” of the drawings in the perspective shown in FIGS. 5A-5D. Each antenna wire is a loop comprising two circumferential sections, 52 and 54 and two longitudinal sections 56 and 58. According to some embodiments, each of the circumferential sections 52 and 54 runs along approximately a quarter of the circumference of the tool section 20. In the illustrated embodiment, each of the antenna wires 40, 42, 48, and 50 describe a shape having an inversion center 201 lying along the axis of the tool section 20. Currents I1, I2, I3, and I4 are supplied to, or generated by, the antenna wires 40, 42, 48, and 50 at wire connection boxes (not shown), depending upon whether the antenna is operating as a transmitter or receiver.

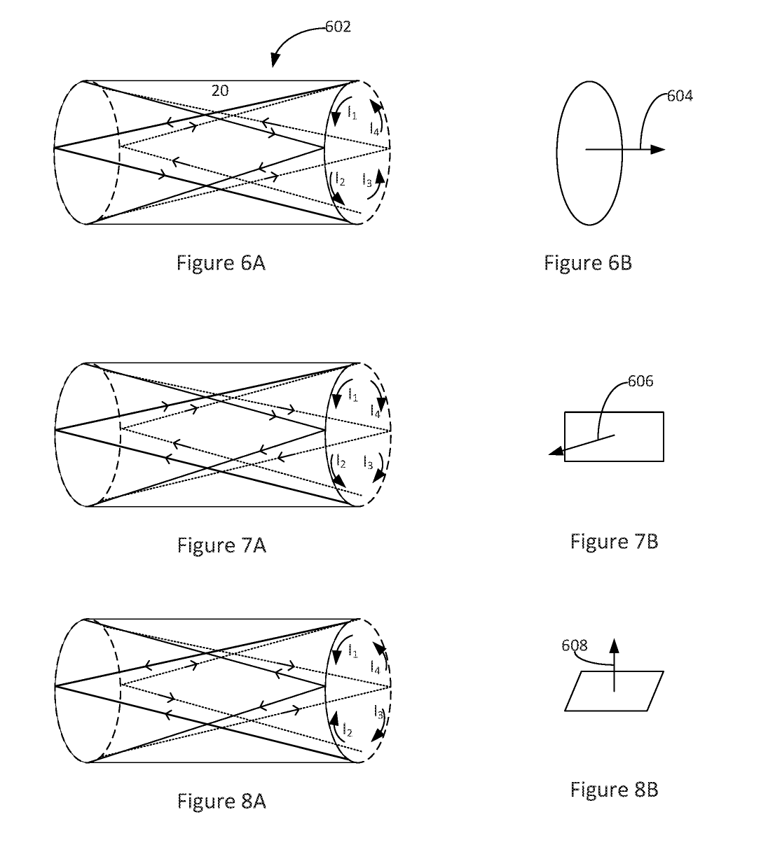

FIGS. 6-8 illustrate an antenna 602 which is a combination of the antenna wires 40, 42, 48, and 50 shown in FIGS. 5A-5D. The antenna 602 is configured within the tool section 20. An understanding of how the steerable magnetic dipole antenna operates can be seen by assuming that the antenna 602 is operating in a transmission mode. The currents I1, I2, I3 and I4 are controlled to direct the magnetic vector from the Z direction (FIGS. 6A and 6B), from the Y direction (FIGS. 7A and 7B), or from the X direction (FIGS. 8A and 8B), or from any direction within the X-Y-Z space. As shown in FIGS. 6A and 6B, when I1=I2=I3=I4, the antenna 602 produces a pure Z dipole moment 604, i.e., a dipole moment in the axial direction. As shown in FIGS. 7A and 7B, when I1=I2=−I3=−I4, the antenna 602 produces a pure Y dipole moment 606. As shown in FIGS. 8A and 8B, when I1=−I2=−I3=I4, the antenna 602 produces a pure X dipole moment 608. Operating as a transmitter, the antenna 602 can generate any dipole direction within the X-Y-Z space by manipulating the exciting current sign and strength within each of antenna wires 40, 42, 48, and 50. Thus, the antenna 602 does not depend on tool rotation to provide a magnetic dipole in all radial directions. The antenna 602 can therefore be used for wireline measurements, as well as MWD measurements. When operating as a receiving antenna, the various portions of the antenna wires 40, 42, 48, and 50 are stimulated by the received EM field and produce a resulting current that is a superposition of the component induced currents in each of the wires.

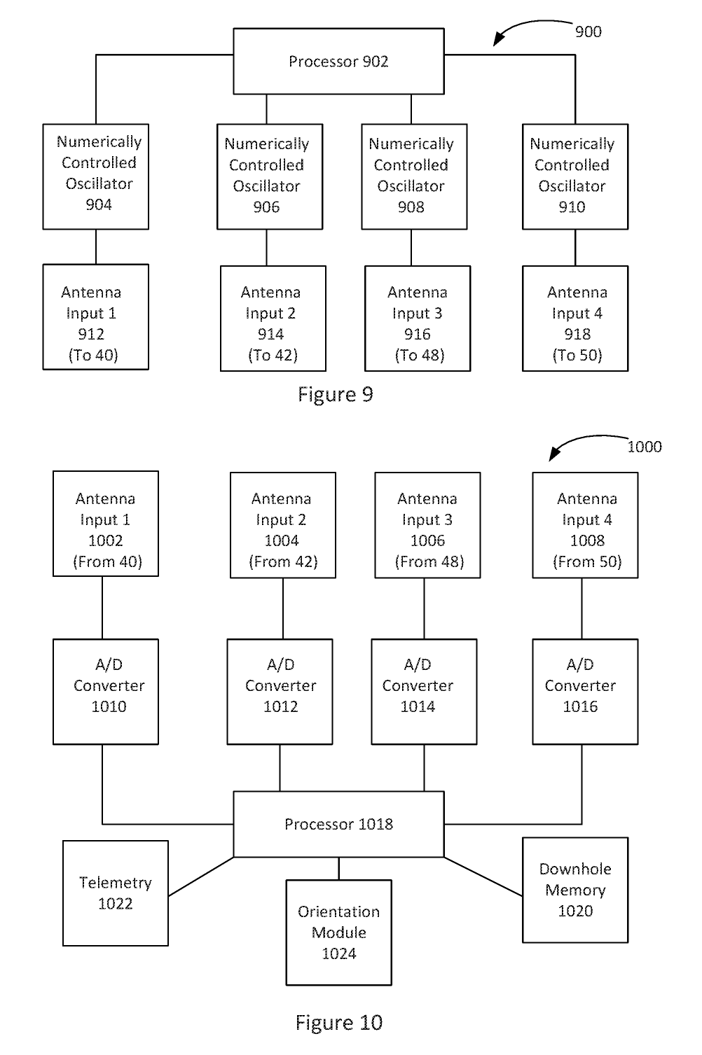

FIG. 9 shows a flow diagram comprising the major antenna transmission elements a transmitter-receiver circuit 900. Operating as a transmitter, a processor 902 sends data to four oscillator based transmitter circuits 904, 906, 908 and 910, which create four antenna input signals. The oscillators are numerically controlled to adjust the input signals to specified frequency, phase, and amplitude. These input signals are the previously discussed antenna input currents I1, I2, I3, and I4 which are indicated conceptually at 912, 914, 916, and 918, respectively. The currents I1, I2, I3, and I4 are input to the antenna at the same frequency via the antenna wire connection boxes (see 44 and 46 of FIG. 4). The phase and amplitude of each individual antenna input is adjusted via the numerically controlled oscillators 904, 906, 908, and 910 to change the amplitude and inclination angle of the resultant antenna magnetic moment, which is a combination of the magnetic moments generated by the individual antenna current inputs. For example, according to one embodiment, the currents I1, I2, I3 and I4 can be controlled to provide a dipole with x, y, z, components Ix, Iy, and Iz, according to the equations:

Iz=(I1+I2+I3+I4)*sin(θ₀);

Ix=(I1−I3)*cos(θ₀):

Iz=(I2−I4)*cos(θ₀);

where the angle θ₀ refers to the tool direction (typically defined as Z-direction). The tilted angle in referring to tool direction (Z-direction) can be:

$$tan ( θ ) = \frac{( I 1 + I 2 + I 3 + I 4 )}{{\sqrt{{( I 1 - I 3 )}^{2} + {( I 2 - I 4 )}^{2}}}^{ }} tan ( {θ}_{0} )$$

Preferably mathematical computations are performed in the processor 902.

FIG. 10 shows a flow diagram comprising the major antenna receiver elements of the transmitter-receiver circuit 1000. When the operated as a receiver, the physical elements of the antenna are largely identical to the antenna operating as a transmitter; the process is simply reversed. Input signals 1002, 1004, 1006 and 1008 from the antenna wires 40, 42, 48, and 50 are input via the antenna wire connection boxes (see 44 and 46 of FIG. 4) to a first analog to digital (A/D) circuits 1010, 1012, 1014, and 1016, respectively. The A/D circuits condition the respective input signals and then convert these signals to digital form. The digitized signals are input into the processor 1018, which may be the same processor 902 that is used in the transmitter portion (see FIG. 9) of the transmitter-receiver circuit 900. The processor 1018 may preferably be a digital signal processor (DSP). The input signals are then processed and the phase and amplitude of each signal is computed. The four signals are then combined to produce a single signal, which reacts only to a magnetic vector at a particular direction in the X-Y-Z space. Results can then be stored in downhole memory at 1020 or telemetered to the surface of the earth via a real time MWD telemetry system 1022. Alternately, measured or “raw” data may be stored in the downhole memory at 1020 or telemetered to the surface of the earth for subsequent processing. Both methods of data storage and transmission are known in the art. In addition, an orientation module 1024, which senses the azimuthal angle that the antenna makes with the vertical or the “high side” of the borehole, is simultaneously input to the receiver computer. The orientation data are combined with the received signal data and placed into bins, wherein each bin contains received signal data received when the X-axis and/or the Y-axis of the antenna is in a particular azimuthal direction. In this way, the azimuthal orientation of the antenna data are known and the received data can be stored, transmitted, or processed as a function of azimuth. The orientation module may be composed of a 3-axis magnetometer and/or an inclinometer to sense high side of the hole relative to the earth coordinate system and electronics to relay this information to the receiver computer. It should be noted that transmission and receiving elements described herein, for example, the processor(s), DSPs, transmitter circuits, and the like are known in the art and are described in the references incorporated herein. Such transmission and receiving elements are collectively referred to herein as “control circuitry.”

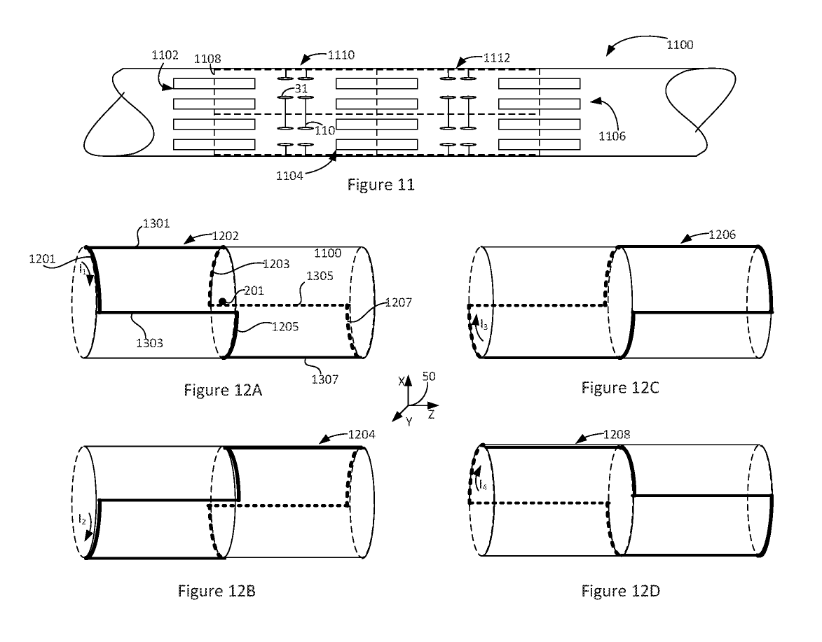

FIG. 11 is a side view of the exterior of an alternative embodiment of a MWD logging tool section 1100 housing a preferred embodiment of a steerable magnetic dipole antenna. The antenna comprises a first set 1102, a second set 1104, and a third set 1106 of axially grooved and laterally spaced antenna elements. The grooves in each set are essentially parallel to the major axis of the tool section 1100, and are azimuthally disposed peripherally around the outer surface of the housing (see FIGS. 1A-IC). The tool section includes an antenna 1108, which comprises four antenna wires, as explained in more detail below. Sections of antenna 1108 perpendicular to the axis of the tool section 1100, traverse each groove set 1102, 1104, and 1106. Sections of the antenna 1108 also traverse tool housing material between grooves within wireways (not shown). Broken lines represent the wires of the antenna 1108 beneath the outer surface on the tool.

Again referring to FIG. 11, a first set 1110 and a second set 1112 of transversally directed hole antenna elements are shown with hole openings 31. Each set of transversally directed hole antenna elements comprise four sub-sets of hole antenna elements disposed at roughly 90° about the circumference of the housing between the first 1102 and second 1104 sets of axial grooves and between the second 1104 and third 1106 sets of axial grooves. Axial portions of the antenna 1108, which are portions parallel to the axis of the tool section 1100, may be disposed within in a common wireway or in separate wireways and are disposed above the ferrite in the holes as shown in detailed FIG. 2A. Slits between the holes are again denoted as 110. As with the embodiment illustrated in FIG. 4, the ends of the antenna wires 1108 terminate at antenna wire connection boxes, which are omitted in FIG. 11 for clarity.

FIGS. 12A-12D show the configurations of antenna wires 1202, 1204, 1206 and 1208, that collectively form the antenna 1108. Note that in FIGS. 12A-12D solid lines represent lines that are on the “front” of the drawings and dashed lines represent lines that are on the “back” of the drawings in the perspective shown in FIGS. 12A-12D. Each antenna wire forms a loop comprising four circumferential sections 1201, 1203, 1205, and 1207 and four longitudinal sections 1301, 1303, 1305, and 1307. According to some embodiments, each of the circumferential sections 1201, 1203, 1205, and 1207 run circumferentially along about a quarter of the circumference of the tool section 1100. In the illustrated embodiment, each of the antenna wires 1202, 1204, 1206 and 1208 describe a shape having an inversion center 201 lying along the axis of the tool section 1100. Currents I1, I2, 13, and 14 are supplied to, or generated by, the antenna wires 1202, 1204, 1206 and 1208 at wire connection boxes (not shown), respectively, depending upon whether the antenna is operating as a transmitter or receiver.

FIGS. 13-15 illustrate an antenna 1108, which is a combination of the antenna wires 1202, 1204, 1206 and 1208 shown in FIGS. 12A-12D. The antenna 1108 is configured within the tool section 1100 (FIG. 11). An understanding of how the steerable magnetic dipole antenna operates can be seen by assuming that the antenna 1108 is operating in a transmission mode. The currents I1, I2, I3 and I4 (FIGS. 12A-12D) are controlled to direct the magnetic vector from the Z direction (FIGS. 13A and 13B), from the Y direction (FIGS. 14A and 14B), or from the X direction (FIGS. 15A and 15B), or from any angle within the X-Y-Z space. As shown in FIGS. 13A and 13B, when I1=I2=I3=I4, the antenna 1108 produces a pure Z dipole moment 604, i.e., a dipole moment in the axial direction. As shown in FIGS. 14A and 14B, when I1=I2=−I3=−I4, the antenna 602 produces a pure Y dipole moment 606. As shown in FIGS. 15A and 15B, when I1=−I2=−I3=I4, the antenna 602 produces a pure X dipole moment 608. Operating as a transmitter, the antenna 1108 can generate any dipole direction within the X-Y-Z space by manipulating the exciting current sign and strength within each of antenna wires 1202, 1204, 1206 and 1208. Generally, operating as a transmitter, the x, y, and z dipoles Ix, Iy, and Iz may be calculated as:

Iz=(I1+I2+I3+I4)

Ix=(I1−I2−I3+I4)

Iy=(I1+I2−I3−I4);

and operating as a receiver:

Vz=(V1+V2+V3+V4)

Vx=(V1−V2−V3+V4)

Vy=(V1+V2−V3−V4)

Thus, the antenna 1108 does not depend on tool rotation to provide a magnetic dipole in all radial directions. The antenna 1108 can therefore be used for wireline measurements, as well as MWD measurements. As with the antenna 602 described above, the antenna 1108 can operate as a transmitter or as a receiver.

As with the antenna embodiment 602 illustrated in FIGS. 4-8, the antenna 1108 interfaces with the elements of a transmitter-receiver circuit 900/1000, as illustrated in FIGS. 9 and 10. The operation of such transmitter-receiver circuit(s) 900/1000 are described above, and need not be repeated here.

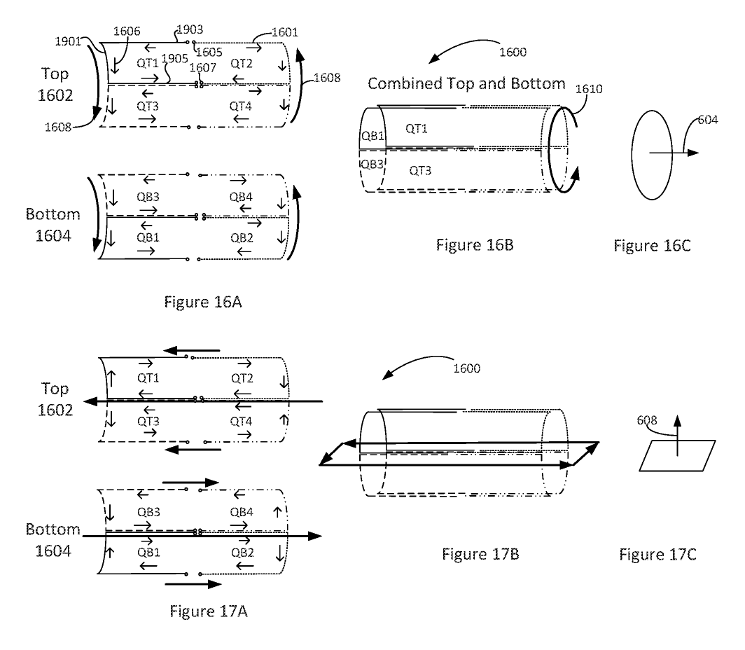

FIGS. 16-18 illustrate an alternative embodiment a steerable magnetic dipole antenna 1600 for a MWD logging tool. The antenna 1600 includes a top half-cylinder shell section 1602 and a bottom half-cylinder shell section 1604, as illustrated in FIG. 16A. Each half-cylinder shell section comprises four antenna wires 1601, each defining a quadrant of their respective half-cylinder shell sections. Each antenna wire is represented by lines having different dashed patterns and the respective quadrants are labeled QT1 for top quadrant 1, QT2 for top quadrant 2, QB1 for bottom quadrant 1, etc. Each antenna wire comprises a single hemispherical active section 1901 and two longitudinal active sections 1903 and 1905. Each antenna wire may exit from a hole 1605 in the cylinder body and enter the cylinder body at another hole 1607. It should be noted that the antenna wires 1601 may be loop antennas, but wherein one leg of the loop is shielded and does not contribute to the antenna signal. In other wise, if the antenna wire is a loop antenna, one leg of the loop is not active. Current supplied to each of the antenna wires is represented with thin arrows 1606. The thick arrows 1608 represent the resulting macroscopic current of each half-cylinder 1602 and 1604 resulting as the superposition of the individual currents 1606 applied to each antenna wire.

FIG. 16B illustrates a top view of the antenna 1600 when the top half-cylinder section 1602 is configured with the bottom half-cylinder section 1604 such that the antenna wire defining QT1 meets next to the antenna wire defining QB1, etc. When the half-cylinder sections are so combined, the superposition of the currents in each antenna wire produce a macroscopic current for the entire antenna 1600, which is represented by the thick arrow 1610 in FIG. 16B. As illustrated in FIG. 16C, the macroscopic current 1610 produces a magnetic dipole 604 oriented in along the Z axis, i.e., parallel with the radial axis of the antenna 1600.

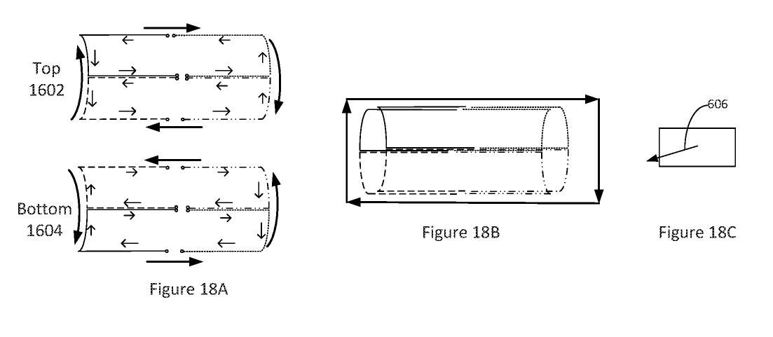

FIGS. 17A-17C illustrate the currents applied to each of the antenna wires to produce a magnetic dipole 608 in the Y direction, i.e., perpendicular to the antenna radial axis. FIGS. 18A-18C illustrate the currents applied to each of the antenna wires to produce a magnetic dipole 606 in the X direction, i.e., perpendicular to the antenna radial axis. The currents to each of the antenna wires can be adjusted to obtain a magnetic moment vector in any predetermined direction. The antenna may also be used as a transmitter or as a receiver. When operating as a receiver, the antenna can receive three orthogonal components, i.e., it can receive, at a single antenna, all full-tensor signals generated at another antenna.

As with the antenna embodiments described above, the antenna embodiment 1600 can be configured within the housing of a tool section. Axial portions of the antenna wires, which are portions parallel to the axis of the tool section, may be disposed within in a common wireway or in separate wireways and may be disposed above the ferrite in hole antenna elements as described above. Sections of the antenna wires that are perpendicular to the axis of the tool section may be disposed within groove antenna elements. As with the antenna embodiments 602 and 1108 described above, the antenna embodiment 1600 interfaces with the elements of a transmitter-receiver circuit 900/1000, as illustrated in FIGS. 9 and 10. The operation of such transmitter-receiver circuit(s) 900/1000 are described above, and need not be repeated here.

It will be appreciated that several embodiments of antennas for a MWD logging tool have been described herein. Each antenna embodiment can generate a magnetic dipole in any direction by manipulating the exciting current to the antenna's component antenna wires. Likewise, operating as a receiving antenna, the antenna embodiments can receive full tensor signals in a collated manner, without depending on tool rotation. Thus, the antennas are suitable for wireline, as well as MWD applications. The antenna embodiments can be implemented as a component of any MWD/wireline EM measurement application, as is known in the art.

While the invention herein disclosed has been described in terms of specific embodiments and applications thereof, numerous modifications and variations could be made thereto by those skilled in the art without departing from the scope of the invention set forth in the claims.

What is claimed is:

1. An antenna array formed on a well logging/measuring tool, the antenna array comprising:
first, second, third, and fourth antenna wire loops, wherein
each of the first, second, third, and fourth antenna wire loops comprise at least two circumferential sections disposed along circumferential portions of the tool and at least two longitudinal sections, wherein
the antenna array comprises control circuitry configured to independently control or sense current in the first, second, third, and fourth antenna wire loops.

2. The antenna array of claim 1, wherein no two circumferential sections are coincident.

3. The antenna array of claim 1, wherein each of the circumferential sections are disposed along about one quarter of a circumference of the tool.

4. The antenna array of claim 1, wherein each of the first, second, third, and fourth antenna wire loops comprises two circumferential sections and two longitudinal sections.

5. The antenna array of claim 1, wherein each of the first, second, third, and fourth antenna wire loops comprises four circumferential sections and four longitudinal sections.

6. The antenna array of claim 1, wherein each of the first, second, third, and fourth antenna wire loops describe a shape having an inversion center along the axis of the tool.

7. The antenna array of claim 1, wherein the antenna array is configured to controllably provide a magnetic dipole oriented at any selected azimuthal angle about the tool.

8. The antenna array of claim 1, wherein the tool has a longitudinal axis and wherein the antenna array is configured to controllably provide a magnetic dipole oriented at any selected angle with respect to the longitudinal angle.

9. A well logging/measuring tool comprising:
an antenna array comprising:
first, second, third, and fourth antenna wire loops, wherein
each of the first, second, third, and fourth antenna wire loops comprise at least two circumferential sections disposed along circumferential portions of the tool and at least two longitudinal sections, wherein
control circuitry configured to independently control or sense current in the first, second, third, and fourth antenna wire loops.

10. The tool of claim 9, wherein no two circumferential sections are coincident.

11. The tool of claim 9, wherein each of the circumferential sections are disposed along about one quarter of a circumference of the tool.

12. The tool of claim 9, wherein each of the first, second, third, and fourth antenna wire loops comprises two circumferential sections and two longitudinal sections.

13. The tool of claim 9, wherein each of the first, second, third, and fourth antenna wire loops comprises four circumferential sections and four longitudinal sections.

14. The tool of claim 9, wherein each of the first, second, third, and fourth antenna wire loops describe a shape having an inversion center along the axis of the tool.

15. The tool of claim 9, wherein the antenna array is configured to controllably provide a magnetic dipole oriented at any selected azimuthal angle about the tool.

16. The tool of claim 9, wherein the tool has a longitudinal axis and wherein the antenna array is configured to controllably provide a magnetic dipole oriented at any selected angle with respect to the longitudinal angle.

17. The tool of claim 9, wherein the tool is a MWD tool or a LWD tool.

18. The tool of claim 9, wherein the tool is a wireline tool.

19. An antenna array formed on a well logging/measuring tool, the antenna array comprising:
a first half-cylinder shell and a second half-cylinder shell, wherein
each half-cylinder shell comprises first, second, third and fourth antenna wires, each antenna wire disposed upon a quadrant of the cylinder shell, wherein
each antenna wire comprises a circumferential active section and two longitudinal active sections, and wherein the antenna array comprises control circuitry configured to independently control or sense current in the first, second, third, and fourth antenna wires of each of the half-cylinder shells.

20. The antenna array of claim 19, wherein the first half-cylinder shell and the second half-cylinder shell combine to cylinder.

21. The antenna array of claim 20, wherein the antenna array is configured to controllably provide a magnetic dipole oriented at any selected azimuthal angle about the cylinder.

22. The antenna array of claim 20, wherein the cylinder has a longitudinal axis and wherein the antenna array is configured to controllably provide a magnetic dipole oriented at any selected angle with respect to the longitudinal angle.
